(19) United States
(12) Patent Application Publication
(10) Pub. No.: US 2012/0317256 A1
(43) Pub. Date: Dec. 13, 2012

(54) MANAGEMENT PROTOCOL FOR NETWORK DEVICES

(76) Inventors: Martin Gadbois, Laval (CA); Guy Letoumeau, Boucherville (CA); Eric Perie, Montreal (CA)

(21) Appl. No.: 13/156,415

(22) Filed: Jun. 9, 2011

(51) Int. Cl. G06F 15/173

(52) U.S. Cl. 709/223

(57) ABSTRACT

A management console includes a processor and a memory communicatively coupled to the processor. The memory stores instructions causing the processor, after execution of the instructions by the processor, to transmit a message to a network device. The message indicates which status and statistic field values of the network device to transmit to the management console and a time interval for transmitting the field values. The memory stores instructions causing the processor to receive from the network device, at each time interval, a management protocol message including the status and statistic field values.

### BACKGROUND

Computer networks may include a number of various network devices, such as access controllers and wireless access points, for connecting clients to network resources through wired or wireless connections. To monitor and manage the various network devices, a management console connected to the network may be used to gather status and statistics information from the various network devices. Since the network may include thousands of network devices, an efficient method for obtaining the status and statistics information from each of the network devices is needed.

### BRIEF DESCRIPTION OF THE DRAWINGS

FIG. 1 is a block diagram illustrating one example of a system.

FIG. 2 is a flow diagram illustrating one example of data exchanges between a managed device and a management console.

FIG. 3 is one example of a portion of a description file.

FIG. 4 is one example of a table within a managed device including data.

FIG. 5 is one example of a management protocol message.

FIG. 6 is a flow diagram illustrating one example of a process for sending status and statistic data from a managed device to the management console.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

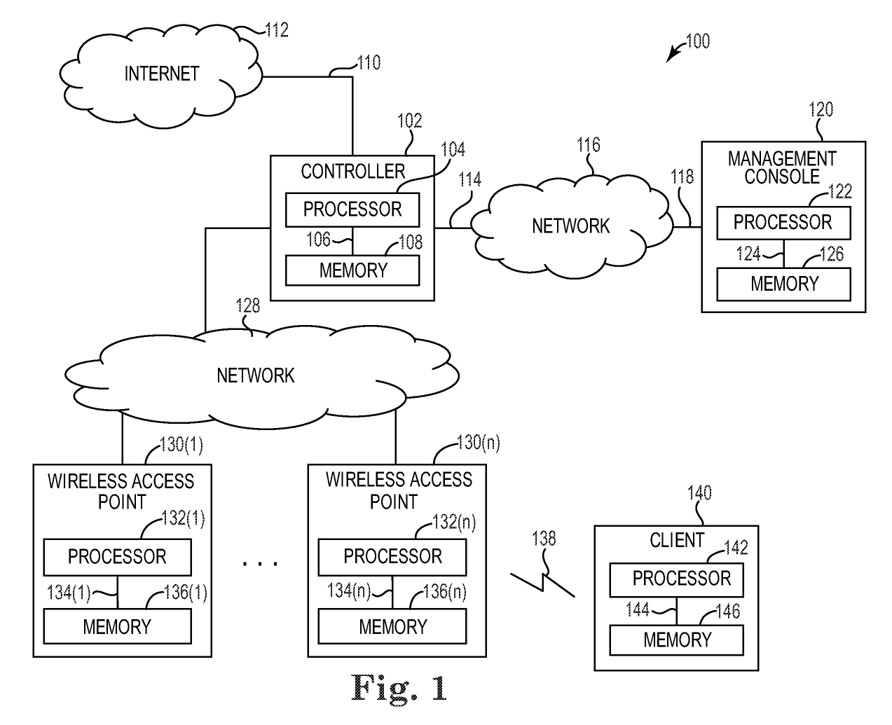

FIG. 1 is a block diagram illustrating one example of a system 100. System 100 includes a controller 102, an internet 112, a network 116, a management console 120, a network 128, wireless access points 130(1)-130(n), where n is any suitable integer, and a client 140. In other examples, system 100 may include any suitable number of controllers 102, wireless access points 130, and clients 140.

Controller 102, wireless access points 130(1)-130(n), and management console 120 use management protocols to transmit status and statistics information from controller 102 and wireless access points 130(1)-130(n) to management console 120. The management protocols provide an efficient method for encoding, transmitting, and decoding the status and statistics information. The management protocols enable system 100 to be scalable by enabling management console 120 to receive status and statistics information from several thousand network devices. In one example, Google™ protocol buffers are used to provide the management protocols.

Management console 120 is communicatively coupled to network 116 through communication path 118. Controller 102 is communicatively coupled to network 116 through communication path 114, to internet 112 through communication path 110, and to wireless access points 130(1)-130(n) through network 128. Wireless access point 130(n) is communicatively coupled to client 140 through wireless communication path 138.

Management console 120 is a server or other suitable device capable of managing network devices including controller 102 and wireless access points 130(1)-130(n). Management console 120 includes a processor 122 and a memory 126. Processor 122 is communicatively coupled to memory 126 through communication path 124. In one example, memory 126 stores instructions executed by processor 122 for operating management console 120. Memory 126 includes any suitable combination of volatile and/or non-volatile memory, such as combinations of random access memory (RAM), read-only memory (ROM), flash memory, and/or other suitable memory.

Network 116 is a local area network, a wide area network, or other suitable network. Network 128 is a local area network, a wide area network, or other suitable network. Management console 120 receives management protocol messages from controller 102 and wireless access points 130(1)-130(n) through network 116. Each management protocol message received includes serialized data in a structured format defined by a description file. Machine readable instructions that implement the description file are stored in memory 126. In one example, each management protocol message is encapsulated in one or more Transmission Control Protocol (TCP) packets. Each management protocol message from a managed device includes status and statistics information for the managed device. In one example, management console 120 stores the received status and statistics information from the managed devices in memory 126. Based on the status and statistics information received in each management protocol message, management console 120 monitors controller 102 and wireless access points 130(1)-130(n). In one example, all wireless devices within range of network 116 and network 128 may be reachable by management console 120, including controlled or autonomous wireless access points, controllers of wireless access points, legacy devices (i.e., radio ports and wireless services modules), neighbors, and rogue devices.

In one example, management console 120 includes status reporting that provides a constant overview of network health at a glance, with the ability to drill down for specific details. Management console 120 provides tools for near real-time monitoring, troubleshooting, and compliance auditing of the wireless network, including: tools for monitoring Wireless Local Area Networks (WLANs), wireless access points, and controllers; tools for identifying rogue devices and ad hoc connections; and tools for fine tuning existing networks and planning new ones.

Controller 102 is an access controller, which is a network device for managing wireless access points 130(1)-130(n). Controller 102 passes communications between internet 112 and network 128 and between network 128 and network 116. Controller 102 includes a processor 104 and a memory 108. Processor 104 is communicatively coupled to memory 108 through communication path 106. In one example, memory 108 stores instructions executed by processor 104 for operating controller 102. Memory 108 includes any suitable combination of volatile and/or non-volatile memory, such as combinations of RAM, ROM, flash memory, and/or other suitable memory.

Controller 102 generates and transmits management protocol messages to management console 120 through network 116. Each management protocol message transmitted includes serialized data in a structured format defined by a description file. Machine readable instructions that implement the description file are stored in memory 108. In one example, each management protocol message is encapsulated in one or more TCP packets. Each management protocol message includes status and statistics information for controller 102. In one example, the status and statistics information for controller 102 is maintained by tables stored in memory 108.

Controller 102 provides centralized management and control of wireless access points 130(1)-130(n). Controller 102 automates discovery, authentication, and configuration for installed wireless access points 130(1)-130(n). In one example, the authentication uses digital certificates to assure security and to eliminate the risk of rogue wireless access point connectivity. Once authenticated, controller 102 establishes a secure management tunnel for the exchange of configuration and control information with each wireless access point 130(1)-130(n). Controller 102 eliminates time-consuming wireless access point configuration, troubleshooting, and maintenance tasks by providing a single management interface for the entire group of wireless access points 130(1)-130(n) managed by controller 102. In one example, controller 102 automates installation of wireless access point software updates and ensures a consistent set of services are delivered throughout network 128. In one example, all security, Quality of Service (QoS), and other policies may be centrally defined through controller 102 via a secure Web-based management tool.

Each wireless access point 130(1)-130(n) passes communications between clients, such as client 140, and network 128 through a wireless connection, such as wireless communication path 138. Each wireless access point 130(1)-130(n) includes a processor 132(1)-132(n) and a memory 136(1)-136(n), respectively. Each processor 132(1)-132(n) is communicatively coupled to memory 136(1)-136(n) through a communication path 134(1)-134(n), respectively. In one example, each memory 136(1)-136(n) stores instructions executed by processor 132(1)-132(n) for operating each wireless access point 130(1)-130(n), respectively. Each memory 136(1)-136(n) includes any suitable combination of volatile and/or non-volatile memory, such as combinations of RAM, ROM, flash memory, and/or other suitable memory.

Each wireless access point 130(1)-130(n) generates and transmits management protocol messages to management console 120 through network 128, controller 102, and network 116. Each management protocol message transmitted includes serialized data in a structured format defined by a description file. Machine readable instructions implementing the description file are stored in each memory 136(1)-136(n). In one example, each management protocol message is encapsulated in one or more TCP packets. Each management protocol message transmitted by a wireless access point 130(1)-130(n) includes status and statistics information for the wireless access point 130(1)-130(n), respectively. In one example, the status and statistics information for each wireless access point 130(1)-130(n) is maintained by tables stored in memory 136(1)-136(n), respectively.

Client 140 is any device capable of communicating with network 128 over a wireless connection, such as a computer (e.g., a laptop or tablet computer), a smartphone, a gaming system, or other suitable computing device. Client 140 includes a processor 142 and a memory 146. Processor 142 is communicatively coupled to memory 146 through communication path 144. In one example, memory 146 stores instructions executed by processor 142 for operating client 140. Memory 146 includes any suitable combination of volatile and/or non-volatile memory, such as combinations of RAM, ROM, flash memory, and/or other suitable memory.

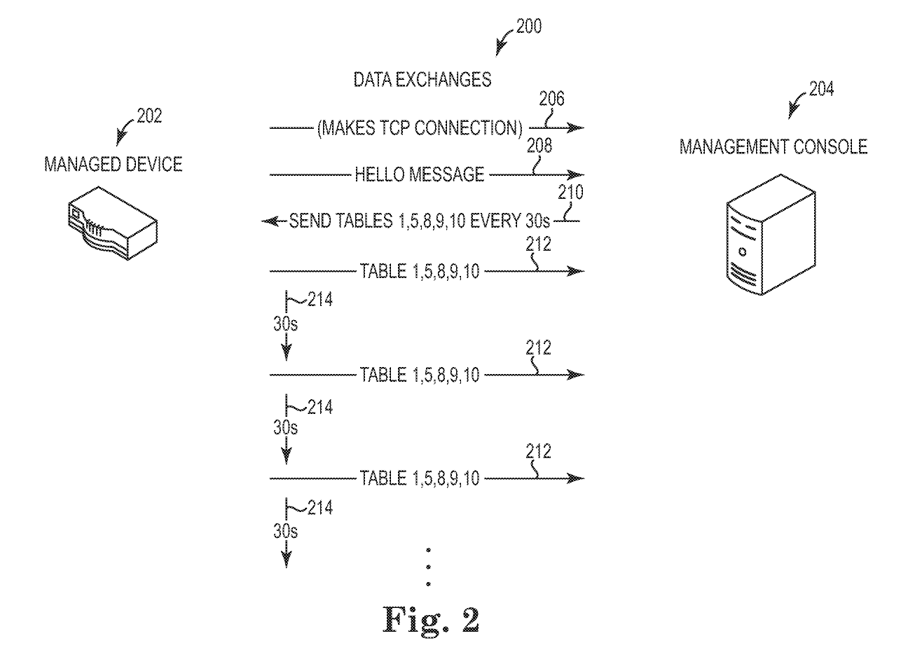

FIG. 2 is a flow diagram illustrating one example of data exchanges 200 between a managed device 202 and a management console 204. In one example, managed device 202 is controller 102 or one of wireless access points 130(1)-130(n) previously described and illustrated with reference in FIG. 1. In other examples, managed device 202 is another suitable network device visible on the network to management console 204 and configured to be managed by management console 204. In one example, management console 204 is management console 120 previously described and illustrated with reference to FIG. 1.

Upon connection and/or power up of managed device 202 to the network, managed device 202 makes a TCP connection to management console 204 as indicated at 206. In other examples, other suitable protocols are used for connecting managed device 202 to management console 204. In one example, managed device 202 connects to management console 204 from behind a Network Address Translation (NAT) router. Once managed device 202 establishes a connection to management console 204, managed device 202 sends a hello message to management console 204 as indicated at 208.

In response to the hello message from managed device 202, management console 204, as indicated at 210, sends a message to managed device 202 indicating which status and statistics information managed device 202 should send to management console 204 and how often managed device 202 should send the specified status and statistics information to management console 204. In one example, management console 204 specifies which status and statistics information managed device 202 should send by listing the tables of managed device 202 that contain the desired status and statistics information.

In the example illustrated in FIG. 2, management console 204 sends a message to managed device 202 indicating that managed device 202 should send the status and statistics information contained within tables 1, 5, 8, 9, and 10 of managed device 202 to management console 204 every 30 seconds. In other examples, management console 204 sends a message to managed device 202 indicating that managed device 202 should send the status and statistics information contained within other suitable tables of managed device 202 to management console 204 at another suitable time interval. In other examples, management console 204 sends a message to managed device 202 indicating that managed device 202 should send the status and statistics information contained within tables of managed device 202 to management console 204 with an individual time interval for each table.

In response to the message from management console 204 as indicated at 210, managed device 202 sends the requested current status and statistics information to management console 204 as indicated at 212. After the specified time interval has elapsed as indicated at 214, managed device 202 again sends the requested updated status and statistics information to management console 204 as indicated at 212. Thereafter, managed device 202 continues to send the requested updated status and statistics information to management console 204 at the specified time interval. In the example illustrated in FIG. 2, managed device 202 sends the status and statistics information contained within tables 1, 5, 8, 9, and 10 of managed device 202 to management console 204 every 30 seconds.

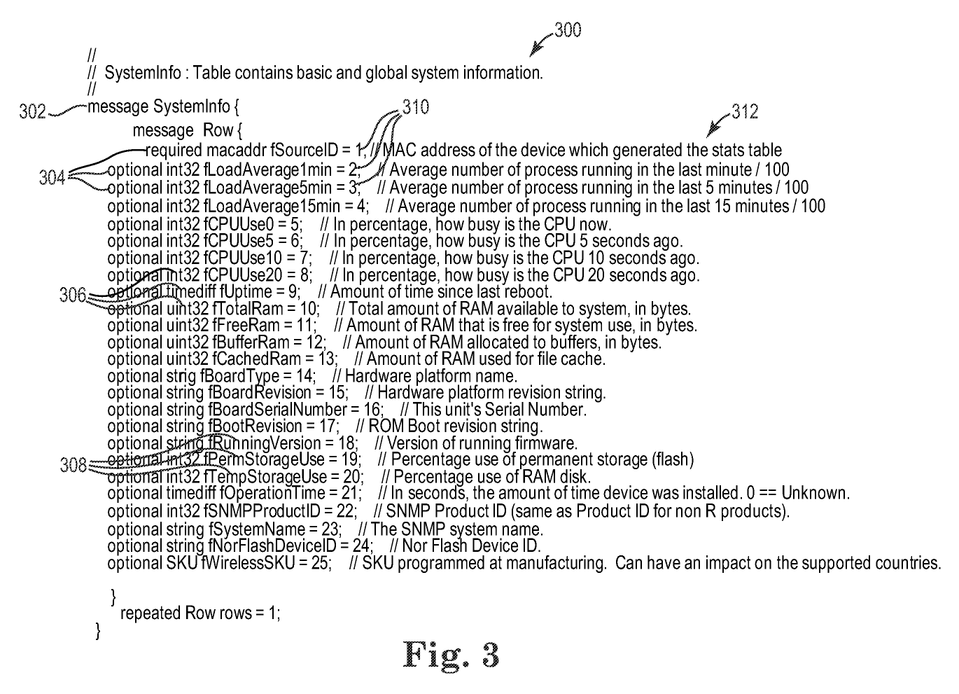

FIG. 3 is one example of a portion 300 of a description file. In one example, portion 300 is a portion of a .proto file. A description file defines the data structures and message types used to encode and decode the management protocol messages sent from a managed device to the management console. Machine readable instructions implementing the description files are stored in both the memory of the managed device and the memory of the management console. The description file acts as a contract between the management console and managed devices by providing a format for data structures and management protocol messages. The description file of the managed device is used for encoding status and statistic field values of the managed device into management protocol messages to send to the management console. The description file of the management console is used for decoding the management protocol messages received from managed devices to extract the status and statistic field values.

The example description file portion 300 includes a message type SystemInfo, as indicated at 302, which defines a message structure including status and statistics information related to the system information for the managed device. Each message type includes one or more fields. Each field is uniquely numbered as indicated for example at 310. Each field also includes a name, as indicated for example at 308, and a value type as indicated for example at 306. The value types can be numbers (integer or floating-point), booleans, strings, raw bytes, or other management protocol message types. Each field is specified as optional, required, or repeated as indicated for example at 304. The example description file portion 300 also includes a brief description of each field as indicated at 312. In other examples, the description file includes any suitable number of message types where each message type includes any suitable number of fields for defining the structure of management protocol messages for transmitting the status and statistics information.

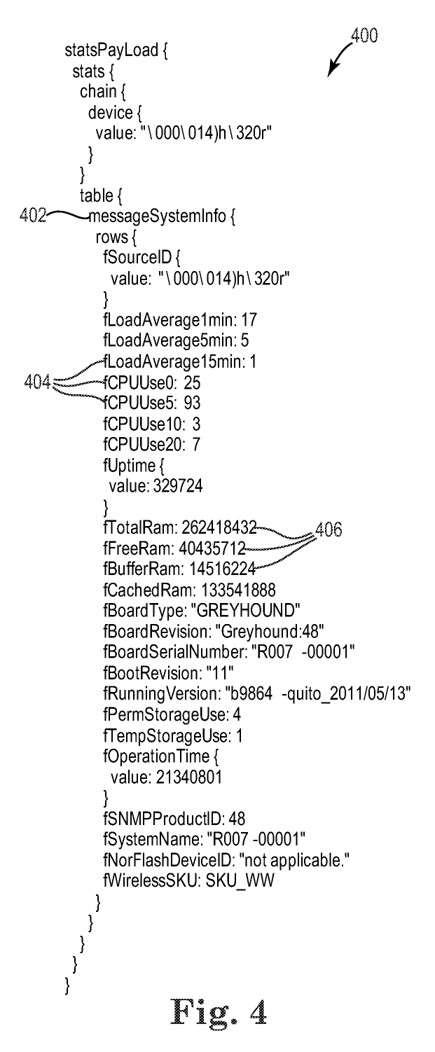

FIG. 4 is one example of a table 400 within a managed device including data. In one example, table 400 is stored within the memory of a managed device and kept updated by the managed device. Table 400 includes the data values for a System Info message, as indicated at 402, which corresponds to the message type SystemInfo of example description file portion 300 previously described and illustrated with reference to FIG. 3. Table 400 includes field names, as indicated for example at 404, and corresponding field values, as indicated for example at 406. The field names of table 400 correspond to the field names of example description file portion 300. In this example, each message type (e.g., message type 302 previously described and illustrated with reference to FIG. 3) includes fields from one table (e.g., table 400). In other examples, each message type may include fields from more than one table of a managed device.

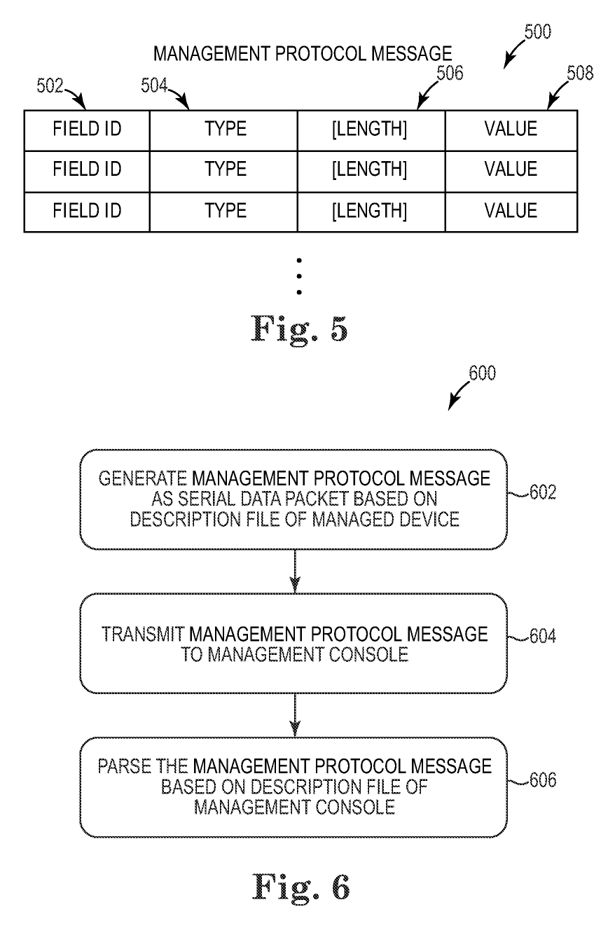

FIG. 5 is one example of a management protocol message 500. Management protocol message 500 is a data packet including serialized data. Each portion of the serialized data includes a field identifier 502, a type 504, a length 506, and a value 508 for the field of the specified type and length. The length 506 for each portion of the serialized data may be excluded if the type 504 for the portion implies a length. Each value 508 of each portion of the serialized data may include additional field identifiers 502 with corresponding types 504, lengths 506, and values 508, which may in turn include additional field identifiers 502 with corresponding types 504, lengths 506, and values 508, etc., in a hierarchical manner.

A managed device generates a management protocol message 500 based on the description file of the managed device and the tables storing the status and statistics information for the managed device. For example, a managed device may generate a management protocol message 500 including the status and statistic field values maintained by table 400 previously described and illustrated with reference to FIG. 4 based on the data structure defined by description file portion 300 previously described and illustrated with reference to FIG. 3.

FIG. 6 is a flow diagram illustrating one example of a process 600 for sending status and statistics information from a managed device to the management console. At 602, a managed device, such as controller 102 or a wireless access point 130(1)-130(n) previously described and illustrated with reference to FIG. 1, generates a management protocol message as a serial data packet based on the description file of the managed device. The status and statistic field values from specified tables (e.g., table 400 previously described and illustrated with reference to FIG. 4) within the managed device are encoded based on the description file (e.g., description file portion 300 previously described and illustrated with reference to FIG. 3) to provide a management protocol message (e.g., management protocol message 500 previously described and illustrated with reference to FIG. 5).

At 604, the management protocol message generated by the managed device is transmitted to the management console, such as management console 120 previously described and illustrated with reference to FIG. 1. At 606, the management console parses the received management protocol message based on the description file of the management console. Based on the description file, the management console decodes the management protocol message to extract the status and statistic field values for the managed device.

Examples use management protocols to efficiently encode status and statistics information from managed devices to provide management protocol messages, transmit the management protocol messages from the managed devices to a management console, and decode the management protocol messages at the management console to extract the status and statistics information for the managed devices. The use of management protocols is efficient in both processing resources and in bandwidth. Management protocols simplify the collection of status and statistics information from managed devices, thereby enabling a management console to mange several thousand network devices.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A management console comprising:
a processor; and
a memory communicatively coupled to the processor, the memory storing instructions causing the processor, after execution of the instructions by the processor, to:
transmit a message to a network device, the message indicating which status and statistic field values of the network device to transmit to the management console and a time interval for transmitting the field values; and
receive from the network device, at each time interval, a management protocol message including the status and statistic field values.

2. The management console of claim 1, wherein a structure of the management protocol message is defined by a description file.

3. The management console of claim 2, wherein the memory stores instructions causing the processor, after execution of the instructions by the processor, to further:
parse the management protocol message to extract the status and statistic field values.

4. The management console of claim 1, wherein the connection with the network device comprises a Transmission Control Protocol (TCP) connection.

5. The management console of claim 1, wherein the network device is behind a Network Address Translation (NAT) router.

6. A network device comprising:
a processor; and
a memory communicatively coupled to the processor, the memory storing instructions causing the processor, after execution of the instructions by the processor, to:
establish a connection with a management console when the network device connects to a network;
receive a message from the management console, the message indicating which field values of the network device to transmit to the management console and a time interval for transmitting the field values; and
transmit to the management console, at each time interval, a management protocol message including the field values.

7. The network device of claim 6, wherein a structure of the management protocol message is defined by a description file.

8. The network device of claim 7, wherein the memory stores instructions causing the processor, after execution of the instructions by the processor, to further:
generate the management protocol message as a serial data packet encoded with the field values based on the description file.

9. The network device of claim 6, wherein the network device comprises one of an access controller and a wireless access point.

10. The network device of claim 6, wherein the management protocol message is encapsulated in a Transmission Control Protocol (TCP) packet.

11. A method for managing network devices, the method comprising:
establishing a connection between a network device and a management console when the network device connects to a network;
transmitting a message from the management console to the network device, the message indicating which status and statistic field values of the network device to transmit to the management console and a time interval for transmitting the field values; and
receiving at the management console from the network device, at each time interval, a management protocol message including the status and statistic field values.

12. The method of claim 11, further comprising:
defining a structure of the management protocol message via a description file.

13. The method of claim 12, further comprising:
parsing the management protocol message received at the management console based on the description file to extract the status and statistic field values.

14. The method of claim 11, wherein establishing the connection comprises establishing a connection between the management console and one of an access controller and a wireless access point.

15. The method of claim 11, further comprising:
transmitting a hello message from the network device to the management console,
wherein transmitting the message comprises transmitting the message from the management console to the network device in response to the hello message.
